(19) United States
(12) Patent Application Publication
(10) Pub. No.: US 2015/0039300 A1
(43) Pub. Date: Feb. 5, 2015

(54) VEHICLE-MOUNTED COMMUNICATION DEVICE

(71) Applicant: PANASONIC CORPORATION, Kadoma-shi, Osaka (JP)

(72) Inventor: Naoya Mochiki, Kanagawa (JP)

(21) Appl. No.: 14/384,089

(22) PCT Filed: Mar. 8, 2013
(86) PCT No.: PCT/JP2013/001495

§ 371 Date: Sep. 9, 2014

(30) Foreign Application Priority Data
Mar. 14, 2012 (JP) 2012-057018

(51) Int. Cl. G10L 21/0208; G10L 25/93

(52) U.S. Cl. CPC G10L 21/0208; G10L 25/93
USPC 704/226

(57) ABSTRACT

An in-vehicle communication device includes: a noise removal filter and a noise suppressor which are configured to remove running noise superimposed on a voice signal collected by a microphone; a band energy ratio corrector for correcting a band energy ratio reduced by the noise removal filter and the noise suppressor; and a variable bitrate encoder for transmitting a speech voice to the other party via a telephone network, the variable bitrate encoder compressing the speech voice corrected by the band energy ratio corrector. This can reduce the possibility that a voice classifier of the variable bitrate encoder erroneously determines voiced sound as voiceless sound and the voiced sound is erroneously compressed by voiceless sound-use low bitrate encoding. Consequently, even in low average bitrate communications, the speech voice in the in-vehicle environment can be provided to the other party at high quality.

### TECHNICAL FIELD

The present invention relates to a communication device that can provide a high-quality phone call with a small amount of voice communication data even in a noisy environment.

### BACKGROUND ART

There is known a related-art communication device, which is configured such that frequency characteristics of a digital equalizer, which are adjusted in advance for each voice compression method, a noise suppression amount obtained by a noise suppression circuit, and voice adjusted data obtained by a volume adjustment unit are stored in a memory, and an adjustment parameter is switched for each voice compression method, thereby being capable of preventing degradation of voice transmission capability caused by a difference in the voice compression method (for example, Patent Literature 1).

Further, there is known a related-art low average bitrate voice compression technology, which is configured to perform voice classification into voiced sound, voiceless sound, and the like based on such voice features that voiced sound has energy concentrated in a low bandwidth while voiceless sound of noise has energy concentrated in a high bandwidth, thereby being capable of reducing a voice compression rate in accordance with the result of voice classification (see, for example, Patent Literature 2 and Non Patent Literature 1).

### CITATION LIST

### Patent Literature

[PTL 1] JP 3762621 B

[PTL 2] JP 4550360 B

### Non Patent Literature

[NPL 1] 3GPP2, “Enhanced Variable Rate Codec, Speech Service Option 3 and 68 for Wideband Spread Spectrum Digital Systems”, 3GPP2. C. S0014-B Version 1.0, May, 2006

### SUMMARY OF INVENTION

### Technical Problem

However, when low average bitrate voice compression is used in the related-art communication device, in a noisy environment in which energy is concentrated in a low bandwidth, such as when mounted in a vehicle, the noise suppression circuit removes a low bandwidth of noise and also a low bandwidth of voiced sound simultaneously, with the result that a band energy ratio is decreased. Accordingly, there is a problem in that voiced sound may be erroneously classified as voiceless sound in determination of voice classification and the voice quality may deteriorate.

The present invention has been made in order to solve the related-art problem, and provides an in-vehicle communication device that can reduce the possibility that voiced sound is erroneously classified as voiceless sound in determination of voice classification even in a noisy environment such as when mounted in a vehicle.

### Solution To Problem

In order to achieve the above-mentioned object, according to one embodiment of the present invention, there is provided an in-vehicle communication device, including: voice collection means for collecting a voice of a speaker; noise removal means for removing running noise that is superimposed on the voice of the speaker input to the voice collection means; band energy ratio correction means for correcting a band energy ratio of a voice signal output from the noise removal means; and variable bitrate encoding means for compressing a speech voice corrected by the band energy ratio correction means.

### Advantageous Effects of Invention

According to one embodiment of the present invention, it is possible to reduce the possibility that voiced sound is erroneously classified as voiceless sound in voice classification performed for low average bitrate voice compression because the bandwidth ratio is corrected so that the energy of the high bandwidth may be lower than that of the low bandwidth. Consequently, there is an effect that voice call performance in a noisy environment is improved in low average bitrate voice communications.

### BRIEF DESCRIPTION OF DRAWINGS

FIG. 1 is a block diagram illustrating a configuration of an in-vehicle communication device according to a first embodiment of the present invention.

FIG. 2 is a graph showing amplitude characteristics of a noise removal filter according to the first embodiment of the present invention.

FIG. 3 is a block diagram illustrating an example of a noise suppressor according to the first embodiment of the present invention.

FIG. 4 is a block diagram illustrating an example of a configuration of a band energy ratio corrector according to the first embodiment of the present invention.

FIG. 5 is a block diagram illustrating a configuration of an in-vehicle communication device according to a second embodiment of the present invention.

FIG. 6 is a block diagram illustrating an example of a configuration of a band energy ratio corrector according to a third embodiment of the present invention.

### DESCRIPTION OF EMBODIMENTS

### First Embodiment

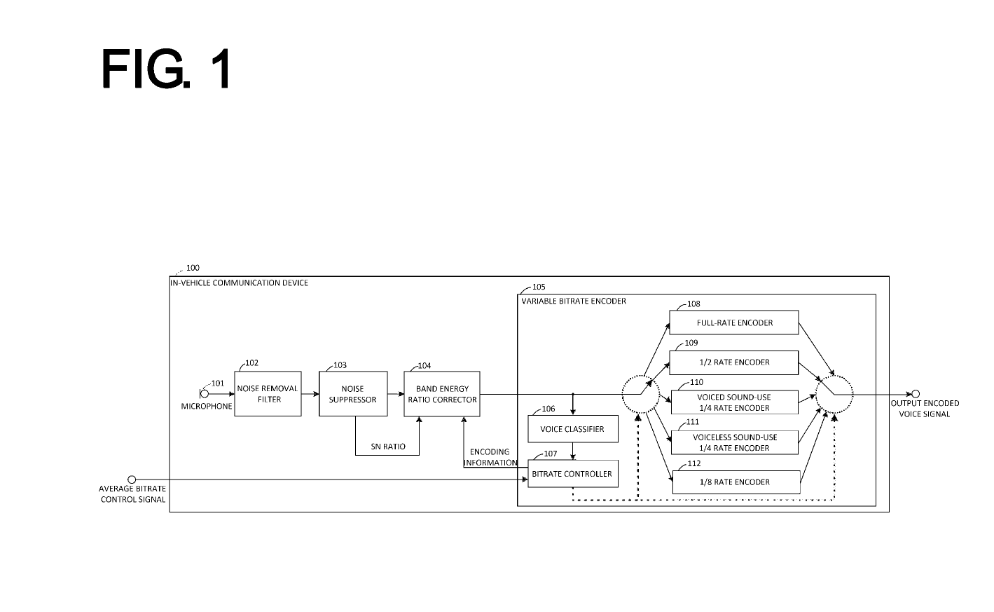

Now, an in-vehicle communication device according to a first embodiment of the present invention is described with reference to the drawings. FIG. 1 is a block diagram of the in-vehicle communication device according to the first embodiment of the present invention.

In FIG. 1, an in-vehicle communication device 100 is configured to input an average bitrate control signal from a telephone network (not shown), and output an output encoded voice signal to be transmitted to the other party to the telephone network.

The in-vehicle communication device 100 includes a microphone 101 for collecting the voice of a speaker, a noise removal filter 102 for removing running noise that has energy concentrated in a low bandwidth, a noise suppressor 103 for suppressing steady running noise by subtracting running noise estimated based on a voiceless segment from a voice signal superimposing the running noise, a band energy ratio corrector 104 for correcting a band ratio of voiced sound lost by the noise removal filter 102 and the noise suppressor 103, and a variable bitrate encoder 105 for transmitting a speech voice to the other party with a small amount of data. The noise removal filter 102 and the noise suppressor 103 may be constructed as single noise removal means having both functions to remove running noise that is superimposed on the voice of the speaker input to the microphone 101.

The variable bitrate encoder 105 includes a voice classifier 106 for classifying the voice signal into voiced sound, voiceless sound, and the like, a bitrate controller 107 for determining an appropriate encoder in accordance with a voice classification result obtained by the classification by the voice classifier 106, and a full-rate encoder 108, a ½ rate encoder 109, a voiced sound-use ¼ rate encoder 110, a voiceless sound-use ¼ rate encoder 111, and a ⅛ rate encoder 112 that are used for the bitrate controller 107 to arbitrarily control an encoding bitrate.

An A/D converter for converting an analog signal into a digital signal may be provided between the microphone 101 and the noise removal filter 102 or between the noise removal filter 102 and the noise suppressor 103.

Further, a near-field communication module as represented by Bluetooth (trademark) may be provided between the band energy ratio corrector 104 and the variable bitrate encoder 105 so as to communicate signals between the band energy ratio corrector 104 and the variable bitrate encoder 105 by wireless.

Processing operations of the in-vehicle communication device 100 configured in this way are described below.

First, the voice of a speaker is input to the microphone 101, and is transmitted to the other party via the telephone network.

In an in-vehicle environment, running noise as well as the voice of the speaker is input to the microphone 101. When the running noise is also transmitted to the other party via the telephone network, it becomes difficult for the other party to hear the voice of the speaker.

In view of this, the noise removal filter 102 and the noise suppressor 103 are used in order to remove the running noise. A voice signal and running noise collected by the microphone 101 are input to the noise removal filter 102.

The noise removal filter 102 operates to attenuate the running noise concentrated in a low bandwidth always by a predetermined amount, to thereby output a signal having an improved signal-to-noise (SN) ratio.

The noise removal filter 102 can be constructed by an infinite impulse response (IIR) filter, for example.

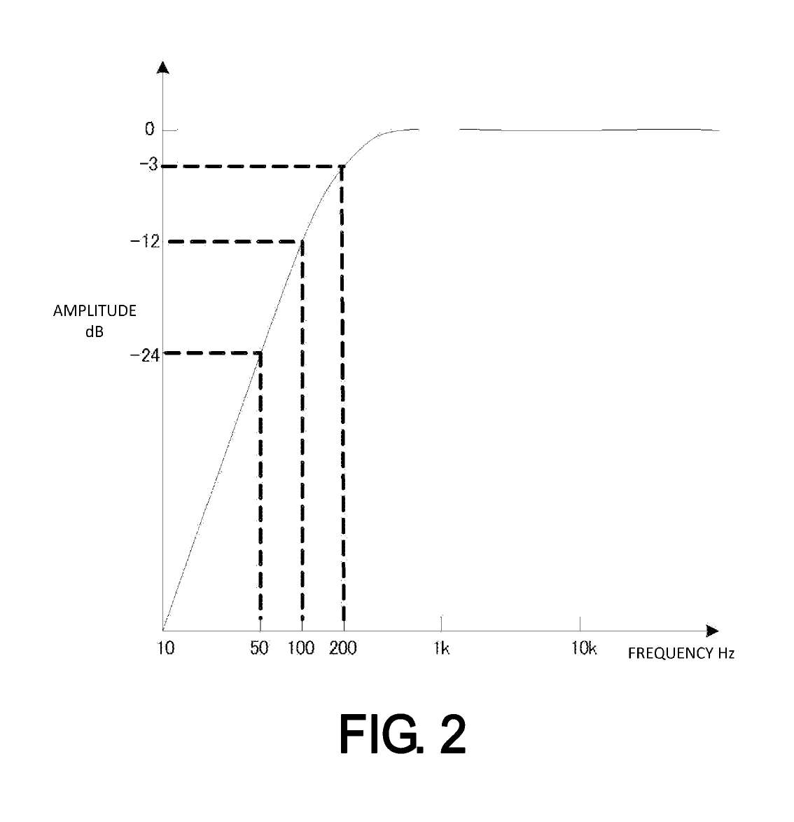

FIG. 2 is a graph showing amplitude characteristics of the noise removal filter 102 in a case where a high pass filter with a cutoff frequency of 200 Hz is designed by a second-order IIR filter. Output amplitude characteristics of the filter show that the running noise can be attenuated by 24 dB at 50 Hz where no voice signal is present but only the running noise is present, and hence the SN ratio can be improved.

On the other hand, the noise removal filter 102 cannot have amplitude characteristics in which the stop band and the pass band are clearly separated, and hence have characteristics of attenuating not only the running noise but also the voice signal in the range from 100 Hz or more to around 300 Hz where the voice signal is present.

The signal having the SN ratio improved by the noise removal filter 102 is input to the noise suppressor 103. The noise suppressor 103 operates to remove a steady running noise component from the input signal, to thereby output a signal having a further improved SN ratio.

The signal having the SN ratio further improved by the noise suppressor 103 is a signal from which the voice signal is also removed simultaneously when the running noise having energy concentrated in the low bandwidth is removed by processing of the noise removal filter 102 and the noise suppressor 103. Accordingly, the signal output from the noise suppressor 103 has higher energy in a high bandwidth than in the low bandwidth irrespective of the fact that the signal is voiced sound.

In this case, voiced sound has such characteristics of voiceless sound that the energy is higher in the high bandwidth than in the low bandwidth. Accordingly, when voiced sound having higher energy in the high bandwidth than in the low bandwidth is input to the variable bitrate encoder 105, the voiced sound is compressed by the voiceless sound-use ¼ rate encoder 111, with the result that phone call quality greatly deteriorates.

The band energy ratio corrector 104 is provided in order to prevent the voiced sound from being compressed by the voiceless sound-use ¼ rate encoder 111. The band energy ratio corrector 104 inputs the output signal of the noise suppressor 103.

The output signal of the noise suppressor 103, which is input to the band energy ratio corrector 104, is output after being corrected so that energy thereof becomes lower in the high bandwidth than in the low bandwidth.

The band energy ratio corrector 104 further inputs an SN ratio output from the noise suppressor 103 and encoding information output from the variable bitrate encoder 105.

The SN ratio output from the noise suppressor 103 and the encoding information output from the variable bitrate encoder 105 are used for the band energy ratio corrector 104 to update the correction of a band energy ratio.

A signal output from the band energy ratio corrector 104 is input to the variable bitrate encoder 105.

The variable bitrate encoder 105 uses any one of the full-rate encoder 108, the ½ rate encoder 109, the voiced sound-use ¼ rate encoder 110, the voiceless sound-use ¼ rate encoder 111, and the ⅛ rate encoder 112 to compress the signal output from the band energy ratio corrector 104.

An output encoded voice, which is output to the outside after being compressed by the variable bitrate encoder 105, is transmitted to the other party via the telephone network.

Further, the signal output from the band energy ratio corrector 104 is input to the voice classifier 106.

The voice classifier 106 classifies the voice signal into any one of voice states such as voiced sound, voiceless sound, and silence based on the output signal of the band energy ratio corrector 104, and outputs the result of voice classification to the bitrate controller 107. Specifically, the voice classifier 106 determines the classification of the voice states based on voice features, such as the periodicity, zero-crossing rate, and band energy ratio between the low bandwidth and the high bandwidth of the input signal.

The result of the voice state classification output from the voice classifier 106 is input to the bitrate controller 107. Further, an average bitrate control signal is input to the bitrate controller 107 from the telephone network in order to control the amount of data to be transmitted to the telephone network in accordance with the congestion of the telephone network.

The bitrate controller 107 selects any one of the full-rate encoder 108, the ½ rate encoder 109, the voiced sound-use ¼ rate encoder 110, the voiceless sound-use ¼ rate encoder 111, and the ⅛ rate encoder 112 based on the voice classification result input from the voice classifier 106 and the average bitrate control signal transmitted from the telephone network.

Further, based on the average bitrate control signal, the bitrate controller 107 determines whether or not to use the voiceless sound-use ¼ rate encoder 111, and outputs encoding information indicating whether or not to use the voiceless sound-use ¼ rate encoder 111.

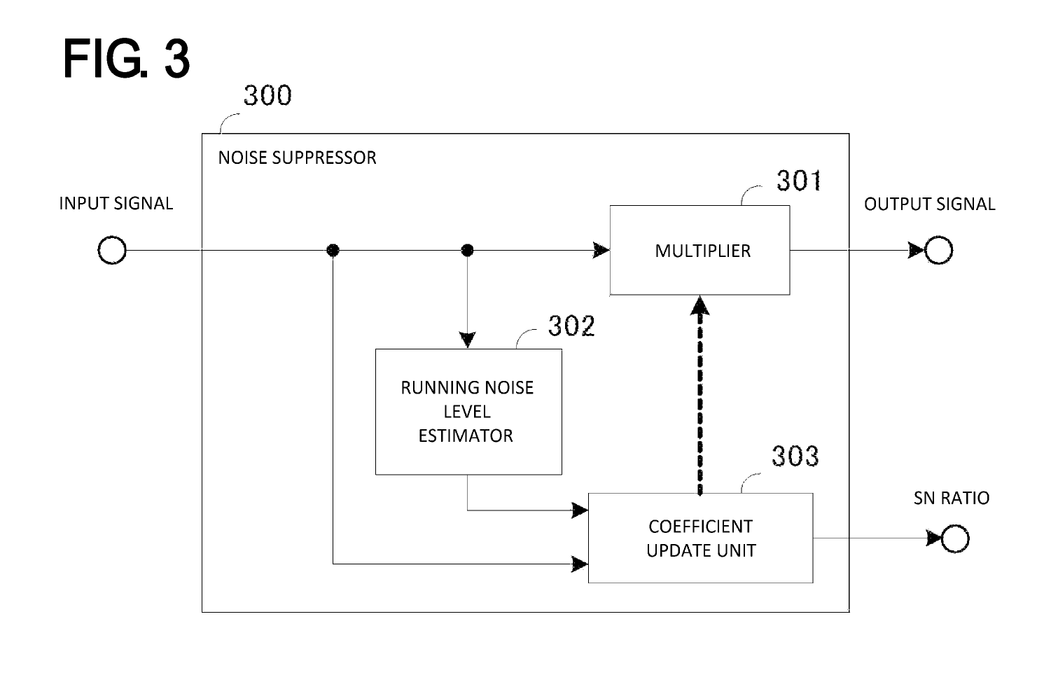

Next, the operation of the noise suppressor 103 is described. FIG. 3 is a block diagram illustrating an example of the noise suppressor 103.

In FIG. 3, reference numeral 300 denotes the noise suppressor; 301, a multiplier for changing the gain of an input signal; 302, a running noise level estimator for estimating the level of running noise contained in the input signal; and 303, a coefficient update unit for updating a coefficient of the multiplier 301 and an SN ratio.

Next, the operation of the noise suppressor 300 configured in this way is described. The gain of an input signal input to the noise suppressor 300 is changed by the multiplier 301, and the resultant is output as an output signal.

Further, the input signal input to the noise suppressor 300 is also input to the running noise level estimator 302. The running noise level estimator 302 estimates the level of running noise based on the input signal. Specifically, the running noise level estimator 302 estimates the level of running noise by performing processing of, for example, minimum value detection on the input signal in which running noise is superimposed on the voice.

Through such processing, it is possible to detect the level of steady running noise in a time section without voice.

The running noise level estimator 302 may estimate the level of running noise by averaging the levels of running noise in sections other than a voice section of the input signal. Also in this case, the level of steady running noise can be detected.

The level of running noise estimated by the running noise level estimator 302 is one of the inputs of the unit for the updated coefficient 303.

The other input of the unit for the updated coefficient 303 is the input signal of the noise suppressor 300. The unit for coefficient update updates the coefficient to be set for the multiplier 301 and the SN ratio.

The coefficient can be calculated as follows, for example. When an amplitude value of the input signal is represented by X, an amplitude value of the running noise estimated by the running noise level estimator 302 is represented by N, and an amplitude value of the output signal is represented by Y, the coefficient is set so that Y=X−N is established. In this case, the coefficient can be set so that the amplitude value of the output signal is determined by subtracting the amplitude value of the running noise from the amplitude value of the input signal.

Both sides of the above expression are divided by X to be Y/X=(X−N)/X, which can be expressed by Y=H·X, where H is H=(X−N)/X.

When H as the coefficient of the multiplier 301 is multiplied by the input signal, a voice signal from which the running noise is subtracted is obtained as an output signal. Note that, those expressions are expressed in terms of amplitude values, and hence the same phase components as those of the input signal are used as phase components of the voice output signal.

Further, the SN ratio can be calculated as follows, for example. Y=H·X and N=X−Y are substituted into Y/N. In this case, Y/N=H·X/(X−Y)=H·X/(X−H·X)=H/(1−H) is established. The SN ratio calculated from H/(1−H) is output from the unit for the updated coefficient 303.

Note that, single multiplication is performed on the whole signal in the above description. Alternatively, however, multiplication processing may be performed in a manner that the input signal is divided into multiple frequency bands and the level of running noise is estimated for each frequency band.

In this case, there is an effect that more detailed control can be performed to improve the effect of suppressing the running noise from the voice.

Now, the operation when the SN ratio is a negative value is described. When the SN ratio is a negative value, a voice signal is buried in running noise, and hence it becomes difficult for the running noise level estimator 302 to detect the voice signal.

Assuming the worst case where the running noise level estimator 302 cannot detect any voice signal at all, the running noise level estimator 302 regards a mixed signal of the voice signal and the running noise as the running noise.

The expression of this state means that the amplitude value N of the running noise is equal to the amplitude value X of the input signal. When the condition of X=N is substituted into H=(X−N)/X, the coefficient H of the multiplier 301 becomes 0, and hence it is understood that the voice signal is also removed together with noise.

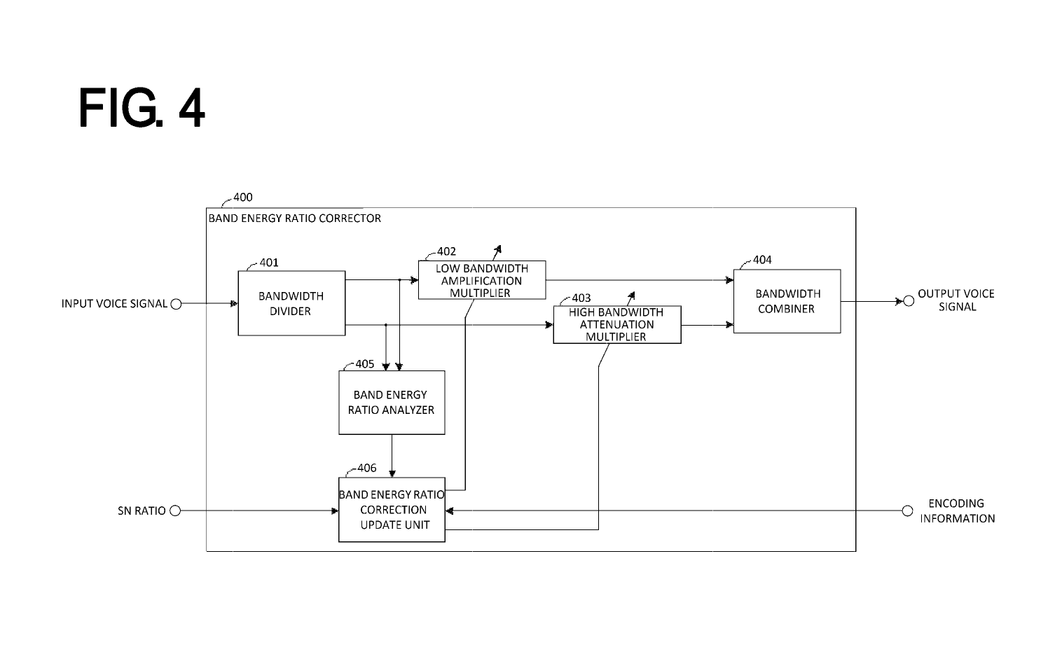

Next, the operation of the band energy ratio corrector 104 is described with reference to FIG. 4. FIG. 4 is a block diagram illustrating an example of the band energy ratio corrector 104.

In FIG. 4, reference numeral 400 denotes the band energy ratio corrector; 401, a bandwidth divider; 402, a low bandwidth amplification multiplier; 403, a high bandwidth attenuation multiplier; 404, a bandwidth combiner; 405, a band energy ratio analyzer; and 406, an update unit of band energy ratio correction.

The operation of the band energy ratio corrector 400 configured in this way is described. An input voice signal input to the band energy ratio corrector 400 is divided by the bandwidth divider 401 into a low bandwidth signal from 0 Hz to 2 kHz frequency and a high bandwidth signal from 2 kHz to 4 kHz frequency.

Note that, the bandwidth divider 401 may be a filter bank for low bandwidth and high bandwidth, which is capable of perfect reconstruction by which the input voice signal is perfectly restored.

Alternatively, the bandwidth divider 401 may use the same bandwidth divider as that used for the voice classifier 106 in downstream processing to analyze the band energy ratio.

This configuration can perform division equivalent to band energy division to be analyzed by the voice classifier 106 in downstream processing, and hence there is an effect that the accuracy of correction of the band energy ratio is improved.

The gains of the low bandwidth signal and the high bandwidth signal, which are output from the bandwidth divider 401, are corrected by the low bandwidth amplification multiplier 402 and the high bandwidth attenuation multiplier 403, respectively, to thereby improve the bandwidth ratio of the input signal.

The low bandwidth signal and the high bandwidth signal, whose gains are corrected by the low bandwidth amplification multiplier 402 and the high bandwidth attenuation multiplier 403, are input to the bandwidth combiner 404. The bandwidth combiner 404 combines the low bandwidth signal and the high bandwidth signal to output as an output voice signal. For example, in the case where the bandwidth divider 401 is a filter bank capable of perfect reconstruction, the bandwidth combiner 404 simply adds together the low bandwidth signal and the high bandwidth signal input to the bandwidth combiner 404, to thereby obtain the combined output voice signal.

Further, the low bandwidth signal and the high bandwidth signal divided by the bandwidth divider 401 are input to the band energy ratio analyzer 405. The band energy ratio analyzer 405 calculates and outputs a band energy ratio based on the low bandwidth signal and the high bandwidth signal input from the bandwidth divider 401. The band energy ratio can be calculated from a calculation expression: 10×log 10(EL/EH), where EL is energy in the low bandwidth and EH is energy in the high bandwidth.

Note that, in the case where near-field communication is performed between the band energy ratio corrector 104 and the variable bitrate encoder 105 with Bluetooth (trademark), amplitude characteristics may attenuate between input and output of Bluetooth (trademark). By adding attenuation amplitude characteristics between input and output of BT communications to the low bandwidth signal and the high bandwidth signal input to the band energy ratio analyzer 405, the resultant signals become equivalent to the input signal that is used for the voice classifier 106 to calculate the band energy ratio. Consequently, there is an effect of improving the accuracy of correction of the band energy ratio.

The band energy ratio, which is output from the band energy ratio analyzer 405, is input to the update unit of band energy ratio correction 406.

The update unit to correct the band energy ratio 406 updates an amplification coefficient of the low bandwidth amplification multiplier 402 or an attenuation coefficient of the high bandwidth attenuation multiplier 403 so that the band energy ratio input from the band energy ratio analyzer 405 may be equal to or higher than any threshold. Specifically, for example, when the band energy ratio is lower than any threshold by 3 dB, update unit of band energy ratio correction 406 updates the coefficient so as to amplify the input signal to the low bandwidth amplification multiplier 402 by 3 dB or to attenuate the input signal to the high bandwidth attenuation multiplier 403 by 3 dB.

When the SN ratio input to the band energy ratio corrector 400 is equal to or higher than any threshold, update unit to correct the band energy ratio 406 updates each coefficient of the low bandwidth amplification multiplier 402 and the high bandwidth attenuation multiplier 403 to 1.

The correction of the band energy ratio reduces the possibility that voiced sound is erroneously determined as voiceless sound when the SN ratio is low, but deteriorates the SN ratio because running noise in the low bandwidth is amplified or a voice signal in the high bandwidth is suppressed.

When the SN ratio is high, the voice classifier 106 can accurately calculate a measure of the periodicity for discrimination between voiced sound and voiceless sound. In this case, the voiced sound is less likely to be erroneously determined as voiceless sound, and hence the SN ratio can be maintained more without the correction of the band energy ratio, thus leading to the improvement of voice quality.

In this manner, when the SN ratio is equal to or higher than any threshold, the update unit of band energy ratio correction 406 updates each coefficient of the low bandwidth amplification multiplier 402 and the high bandwidth attenuation multiplier 403 to 1, and the band energy ratio is not corrected.

Further, update unit of band energy ratio correction 406 determines based on the input encoding information whether the voiceless sound-use ¼ rate encoder 111 operates or not, and updates each coefficient of the low bandwidth amplification multiplier 402 and the high bandwidth attenuation multiplier 403 to 1.

When the voiceless sound-use ¼ rate encoder 111 is not operating in the variable bitrate encoder 105, the voice quality can be improved more without the correction of the band energy ratio, and hence the band energy ratio is not corrected.

Note that, the encoding information is not limited to information indicating whether or not to use the voiceless sound-use ¼ rate encoder 111 and may be encoding information that can indirectly predict whether or not to use the voiceless sound-use ¼ rate encoder 111, for example, a telecommunications carrier and a cellular phone wireless system such as CDMA2000 and UMTS.

As described above, this embodiment can reduce the possibility that the variable bitrate encoder 105 erroneously determines voiced sound as voiceless sound in voice classification and the voiced sound is erroneously compressed by voiceless sound-use low bitrate encoding. Consequently, even in low average bitrate communications, the speech voice of the high quality in the in-vehicle environment can be provided to the other party at high quality.

Note that, in this embodiment, is switched whether the band energy ratio corrector 400 corrects the band energy ratio or not the band energy ratio is switched in accordance with the SN ratio output from the noise suppressor 300 and the encoding information output from the variable bitrate encoder 105, and hence the band energy ratio corrector 400 can be configured not to correct the band energy ratio, which deteriorates the SN ratio, when the correction of the band energy ratio is not necessary. Consequently, there is an effect that the SN ratio is not deteriorated when a signal input to the microphone 101 has a high SN ratio or when a high bitrate encoder is used for the variable bitrate encoder 105.

### Second Embodiment

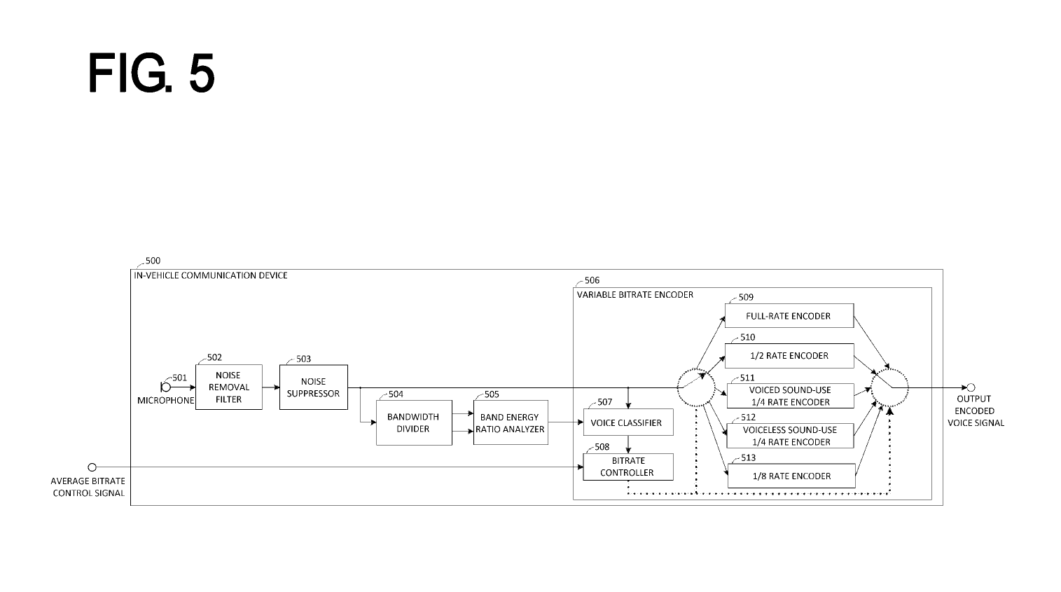

Next, an in-vehicle communication device according to a second embodiment of the present invention is described with reference to FIG. 5. In FIG. 5, similarly to the first embodiment, an in-vehicle communication device 500 is configured to input an average bitrate control signal from a telephone network (not shown), and output an output encoded voice signal to be transmitted to the other party to the telephone network.

The in-vehicle communication device 500 includes a microphone 501 for collecting the voice of a speaker, a noise removal filter 502 for removing running noise that has energy concentrated in a low bandwidth, a noise suppressor 503 for suppressing steady running noise by subtracting running noise estimated based on a voiceless segment from a voice signal having running noise superimposed thereon, a bandwidth divider 504 and a band energy ratio analyzer 505 for analyzing a band ratio of voiced sound reduced by the noise removal filter 502 and the noise suppressor 503, and a variable bitrate encoder 506 for transmitting a speech voice to the other party with a small amount of data.

The variable bitrate encoder 506 includes a voice classifier 507 for classifying the voice signal into voiced sound, voiceless sound, and the like, a bitrate controller 508 for determining an appropriate encoder in accordance with a voice classification result obtained by the classification by the voice classifier 507, and a full-rate encoder 509, a ½ rate encoder 510, a voiced sound-use ¼ rate encoder 511, a voiceless sound-use ¼ rate encoder 512, and a ⅛ rate encoder 513 that are used for the bitrate controller 508 to arbitrarily control an encoding bitrate.

The in-vehicle communication device configured in this way are described below with reference to FIG. 5.

In FIG. 5, the operations of the microphone 501, the noise removal filter 502, the noise suppressor 503, the bandwidth divider 504, the band energy ratio analyzer 505, the bitrate controller 508, the full-rate encoder 509, the 1/2 rate encoder 510, the voiced sound-use ¼ rate encoder 511, the voiceless sound-use ¼ rate encoder 512, and the ⅛ rate encoder 513 are the same as those in the first embodiment.

In the first embodiment, the band energy ratio corrector 104 operates to correct the band energy ratio of the voice signal output from the noise suppressor 103 so as to reduce the possibility that the voice classifier 106 erroneously determines voiced sound as voiceless sound.

In the second embodiment, the band energy ratio is not corrected but an output of the noise suppressor 503 is input to the variable bitrate encoder 506, and the voice classifier 507 uses a band energy ratio output from the band energy ratio analyzer 505 as a band energy ratio threshold used for discrimination between voiced sound and voiceless sound, to thereby operate to reduce the possibility that the voice classifier 507 erroneously determines voiced sound as voiceless sound.

Also the in-vehicle communication device according to the second embodiment of the present invention described above can reduce the possibility that the variable bitrate encoder 506 erroneously determines voiced sound as voiceless sound in voice classification and the voiced sound is erroneously compressed by voiceless sound-use low bitrate encoding. Consequently, even in low average bitrate communications, the speech voice in the in-vehicle environment can be provided to the other party at high quality.

### Third Embodiment

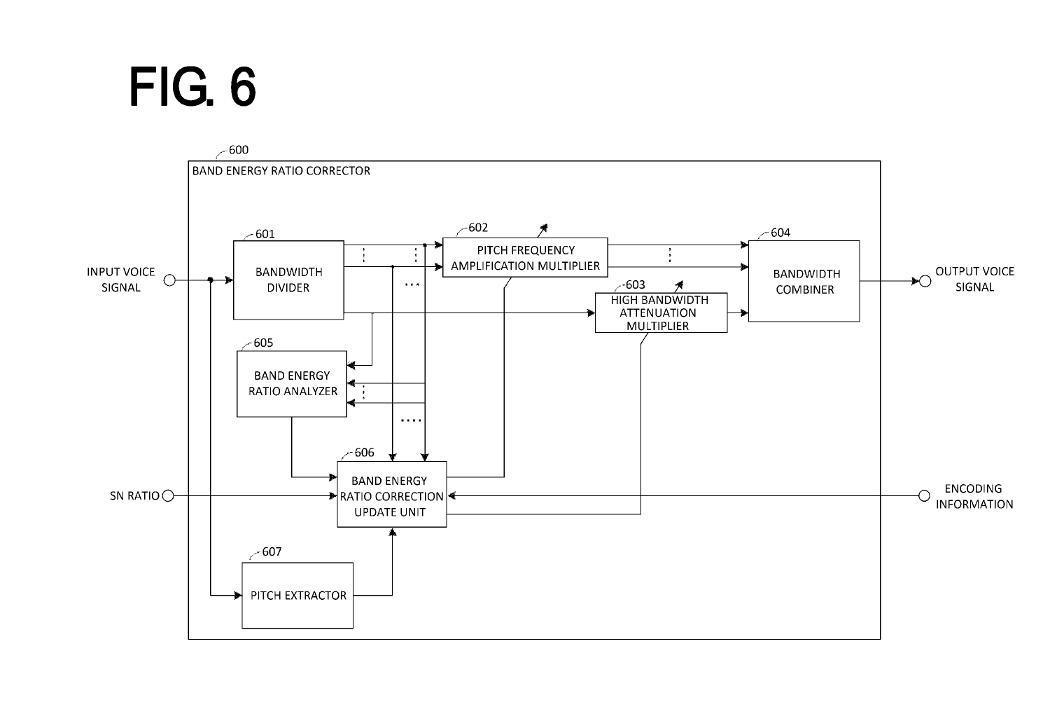

Next, an in-vehicle communication device according to a third embodiment of the present invention is described with reference to FIG. 6. The in-vehicle communication device according to the third embodiment has the same configuration as that of FIG. 1 in the first embodiment.

The third embodiment differs from the first embodiment only in operation of a band energy ratio corrector 600. The operation of the band energy ratio corrector 600 is described with reference to FIG. 6. FIG. 6 is a block diagram illustrating an example of the band energy ratio corrector 600.

In FIG. 6, reference numeral 600 denotes the band energy ratio corrector; 601, a bandwidth divider; 602, a pitch frequency amplification multiplier; 603, a high bandwidth attenuation multiplier; 604, a bandwidth combiner; 605, a band energy ratio analyzer; 606, a band energy ratio correction update unit; and 607, a pitch extractor.

The operation of the band energy ratio corrector 600 configured in this way is described.

The configuration of the band energy ratio corrector 600 is extended from that of the band energy ratio corrector 104 in order to further divide the low bandwidth of from 0 Hz to 2 kHz into any multiple bandwidths.

An input voice signal input to the band energy ratio corrector 600 is divided by the bandwidth divider 601 into multiple low bandwidth signals obtained by arbitrarily dividing the frequency from 0 Hz to 2 kHz, and a high bandwidth signal having a frequency from 2 kHz to 4 kHz.

Note that, the bandwidth divider 601 may be a filter bank for any multiple low bandwidths and high bandwidth, which is capable of perfect reconstruction so that the input voice signal is perfectly restored.

The gains of the multiple low bandwidth signals and the high bandwidth signal, which are output from the bandwidth divider 601, are corrected by the pitch frequency amplification multiplier 602 and the high bandwidth attenuation multiplier 603, respectively. Therefore, the bandwidth ratio of the input signal is improved.

The pitch frequency amplification multiplier 602 includes the same number of multipliers as that of a bandwidth divider for low bandwidth.

The multiple low bandwidth signals and the high bandwidth signal, whose gains are corrected by the pitch frequency amplification multiplier 602 and the high bandwidth attenuation multiplier 603, are input to the bandwidth combiner 604. The bandwidth combiner 604 combines multiple low bandwidth signals and the high bandwidth signals and output as an output voice signal. For example, in the case where the bandwidth divider 601 is a filter bank capable of perfect reconstruction, the bandwidth combiner 604 simply adds together the low bandwidth signal and the high bandwidth signal input to the bandwidth combiner 604, and the combined output voice signal is obtained.

Further, the multiple low bandwidth signals and the high bandwidth signals divided by the bandwidth divider 601 are input to the band energy ratio analyzer 605.

The band energy ratio analyzer 605 calculates and outputs a band energy ratio based on the multiple low bandwidth signals and the high bandwidth signals input from the bandwidth divider 601. The band energy ratio, which is output from the band energy ratio analyzer 605, is input to the band energy ratio correction update unit 606.

The band energy ratio correction update unit 606 updates a coefficient of the pitch frequency amplification multiplier 602 or a coefficient of the high bandwidth attenuation multiplier 603 so that the band energy ratio input from the band energy ratio analyzer 605 may be equal to or higher than any threshold.

Next, a method of updating an amplification coefficient of the pitch frequency amplification multiplier 602 performed by the band energy ratio correction update unit 606 is described.

First, the pitch extractor 607 outputs a pitch frequency from the input voice signal input to the band energy ratio corrector 600.

The pitch frequency, which is output from the pitch extractor 607, is input to the band energy ratio correction update unit 606.

When the band energy ratio correction update unit 606 updates the amplification coefficient of the pitch frequency amplification multiplier 602, the coefficient is amplified for a bandwidth corresponding to a frequency range from the pitch frequency output from the pitch extractor 607 to any integral multiple of the pitch frequency, but the coefficient is not amplified for other irrelevant bandwidths.

As described above, the third embodiment of the present invention can reduce the possibility that the variable bitrate encoder 105 erroneously determines voiced sound as voiceless sound in voice classification and the voiced sound is erroneously compressed by voiceless sound-use low bitrate encoding. Consequently, even in low average bitrate communications, the speech voice of high quality in the in-vehicle environment can be provided to the other party.

Note that, by adding the pitch extractor 607 of the third embodiment to the configuration of the first embodiment, the band energy ratio corrector 104 can correct the band energy ratio only for a frequency range from a pitch frequency in the low bandwidth to any integral multiple of the pitch frequency. Consequently, only the voice signal in the low bandwidth can be amplified without enhancing running noise, and the degradation of the SN ratio caused by the correction of the band energy ratio can be reduced in a bandwidth that is less required to be corrected.

### INDUSTRIAL APPLICABILITY

The in-vehicle communication device according to one embodiment of the present invention has an effect that a high-quality voice call can be provided with a small amount of voice communication data in an in-vehicle environment or the like in which where a signal input to the microphone has a low SN ratio, and can therefore be used as an in-vehicle communication device.

### REFERENCE SIGNS LIST

100, 500 in-vehicle communication device

101, 501 microphone

102, 502 noise removal filter

103, 503 noise suppressor

104 band energy ratio corrector

105, 506 variable bitrate encoder

106, 507 voice classifier

107, 508 bitrate controller

108, 509 full-rate encoder

109, 510 ½ rate encoder

110, 511 voiced sound-use ¼ rate encoder

111, 512 voiceless sound-use ¼ rate encoder

112, 513 ⅛ rate encoder

300 noise suppressor

301 multiplier

302 running noise level estimator

303 coefficient update unit

400, 600 band energy ratio corrector

401, 504, 601 bandwidth divider

402 low bandwidth amplification multiplier

403, 603 high bandwidth attenuation multiplier

404, 604 bandwidth combiner

405, 505, 605 band energy ratio analyzer

406, 606 band energy ratio correction update unit

602 pitch frequency amplification multiplier

607 pitch extractor

1.-5. (canceled)

6. An in-vehicle communication device, comprising:
voice collection means for collecting a voice of a speaker;
noise removal means for removing running noise that is superimposed on the voice of the speaker input to the voice collection means;
band energy ratio correction means for correcting a band energy ratio of a voice signal output from the noise removal means; and
variable bitrate encoding means for compressing a speech voice corrected by the band energy ratio correction means.

7. An in-vehicle communication device according to claim 6, wherein the band energy ratio correction means comprises:
a bandwidth divider for dividing a bandwidth of the voice signal;
a multiplier for correcting a bandwidth ratio of the voice signal;
a band energy ratio analyzer for analyzing the band energy ratio of the voice signal;
a band energy ratio correction update unit for updating a coefficient of the band energy ratio correction means; and
a bandwidth combiner for combining divided bandwidth signals that are corrected for each bandwidth of the voice signal.

8. An in-vehicle communication device according to claim 7, wherein the band energy ratio correction means further comprises a pitch extractor for extracting a pitch frequency of the voice signal.

9. An in-vehicle communication device according to claim 7, wherein the band energy ratio correction update unit comprises encoding information acquisition means for acquiring an SN ratio output from the noise removal means and encoding information output from the variable bitrate encoding means, to thereby prevent the band energy ratio from being corrected when a signal input to the voice collection means has a high SN ratio or when the variable bitrate encoding means uses a high bitrate encoder.

10. An in-vehicle communication device according to claim 8, wherein the band energy ratio correction update unit comprises encoding information acquisition means for acquiring an SN ratio output from the noise removal means and encoding information output from the variable bitrate encoding means, to thereby prevent the band energy ratio from being corrected when a signal input to the voice collection means has a high SN ratio or when the variable bitrate encoding means uses a high bitrate encoder.

11. An in-vehicle communication device, comprising:
voice collection means for collecting a voice of a speaker;
noise removal means for removing running noise that is superimposed on the voice of the speaker input to the voice collection means;
band energy ratio analysis means for analyzing a band energy ratio of a voice signal output from the noise removal means; and
variable bitrate encoding means for using the band energy ratio analyzed by the band energy ratio analysis means as a threshold of the band energy ratio for classifying the voice signal into voiced sound and voiceless sound.
